(19) United States
(12) Patent Application Publication
(10) Pub. No.: US 2010/0005521 A1
(43) Pub. Date: Jan. 7, 2010

(54) Method of Securing Password in Web Page and Computer-Readable Recording Medium Storing Program for Executing the Same

(75) Inventors: Jin Young Kim, Jeollanam-Do (KR); Rok Eun Heo, Seoul (KR)

Correspondence Address: THE WEBB LAW FIRM, P.C., 700 KOPPERS BUILDING, 436 SEVENTH AVENUE, PITTSBURGH, PA, 15219, US

(73) Assignee: KINGS INFORMATION & NETWORK, Seoul (KR)

(21) Appl. No.: 12/182,558

(22) Filed: Jul. 30, 2008

(30) Foreign Application Priority Data
Jul. 4, 2008 (KR) 10-2008-0065132

(51) Int. Cl. H04L 9/32

(52) U.S. Cl. 726/7

(57) ABSTRACT

Provided are a method of securing a password in a web page and a recording medium storing a program for executing the method. The method of accessing a web page provided by a specific web server through a web browser of a user terminal and then securing a password value input from a keyboard of the user terminal to a password input window provided by the web page includes encoding the password value input to the password input window, and then decoding the encoded password value at the same time when a log-in event of the web page occurs. According to the method, it is possible to prevent a password value input to a password input window of a web page from being intercepted by malicious programs before the password value is transmitted to the corresponding web server.

### CROSS REFERENCE TO RELATED APPLICATIONS

This application claims priority from Korean Patent Application No. 10-2008-0065132, filed on Jul. 4, 2008, the disclosure of which is incorporated herein in its entirety by reference.

### BACKGROUND OF THE INVENTION

1. Field of the Invention

The present invention relates to a method of securing a password in a web page, and particularly, to a method of securing a password in a web page that can effectively prevent a password value that is input to a password input window of a web page provided by a specific web server from leaking out due to a malicious program before the password value is transmitted to the web server, and a computer-readable recording medium storing a program for executing the method.

2. Description of the Related Art

Lately, online financial transactions, such as Internet banking, electronic transactions, e-mail transfers, chatting, games, etc., performed via the Internet by individuals, companies and public institutions are sharply increasing.

Particularly in online financial transaction such as Internet banking, or an electronic transaction, an Identification (ID), password, certificate, transfer password, credit card number, social security number, etc., of an Internet user must be input to verify whether the transaction is lawful.

However, such user information is traversed via the Internet, which is an open network, and thus can be vulnerable to cyber criminals.

To prevent hacking and secure data transmission via Internet, a method of installing various security programs, e.g., an anti-spyware program, an anti-virus program, and a firewall, in a user's computer has become standard practice.

However, even if the method of installing various security programs in a user's computer is used, the user's personal information, such as a credit card number and a social security number, the user's password for a web site, etc., are still vulnerable to keyboard driver level hackings.

In addition, a password value that is input to a password input window of a web page can still be read by a method such as hooking or subclassing through the process of transferring password values to an input window. In this way, a malicious program can intercept user's credential such as a user's ID or password.

To prevent this, a keyboard security program is installed in a user's terminal according to conventional art. When the keyboard security program operates, a password value is encoded and then decoded just before it is rendered to an input box of a web page.

By doing this, the input password value cannot be intercepted during the process of transferring the password value to an input window in a web page. However, aforementioned method has a security concern, where password values can be intercepted, after the password values are rendered into the password input window of the web page. Second, if a hacking program identifies a location of the password value in the system memory of a user's PC, the password value can still be obtained by the hacking program.

As described above, the method of securing a keyboard using a keyboard security program according to conventional art can protect a password value during the process of transferring password value from a keyboard to a web page, but such method cannot secure the password value after it has been rendered to the web page, because once the password values are submitted to the web page, malicious hacking programs such as Browser Helper Object can intercept the password value by reading it directly from the web pages

### SUMMARY OF THE INVENTION

The present invention provides a method of securing a password value as an input value to a password input window of a web page from malicious hacking program before the password value is transmitted to the web server.

According to an embodiment of the present invention, a method of securing a password in a web page, includes: (a) determining whether or not a password input window exists in a current web page that is accessed by a web browser on a user terminal; (b) when it is determined in step (a) that a password input window exists in the current web page, checking whether security is configured for the current web page; (c) when it is checked in step (b) that security is configured for the current web page, encoding a password value input from a keyboard of the user terminal to the password input window of a web page; and (d) when an event of logging in to the current web page occurs, decoding the encoded password value.

The method may further include: if it is checked in step (b) that security is not configured for the current web page, displaying a window for security configuration in a screen of the user terminal when the event of logging in to the current web page occurs.

Step (c) may further include: displaying the encoded password value in the password input window after password values are encoded.

Step (d) may further include: storing the decoded password value in the password input window after password value has been encoded.

According to another embodiment of the present invention, a method of accessing a web page provided by a specific web server through a web browser of a user terminal and then securing a password value input to a password input window provided by the web page through a keyboard of the user terminal, the method includes: encoding the password value input to the password input window, and then decoding the encoded password value at the same time when a log-in event of the web page occurs

The method may further include: displaying the encoded password value in the password input window after encoding the password value input to the password input window.

The method may further include: storing the decoded password value in the password input window after decoding the encoded password value.

According to still another embodiment of the present invention. It provides a recording medium, storing a program for executing the above-described method of securing a password in a web page.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 schematically shows the constitution of a system for implementing a method of securing a password in a web page according to an exemplary embodiment of the present invention; and

FIG. 2 is a flowchart showing a method of securing a password in a web page according to an exemplary embodiment of the present invention.

### DETAILED DESCRIPTION OF EXEMPLARY EMBODIMENTS

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided to enable those skilled in the art to easily embody and practice the invention.

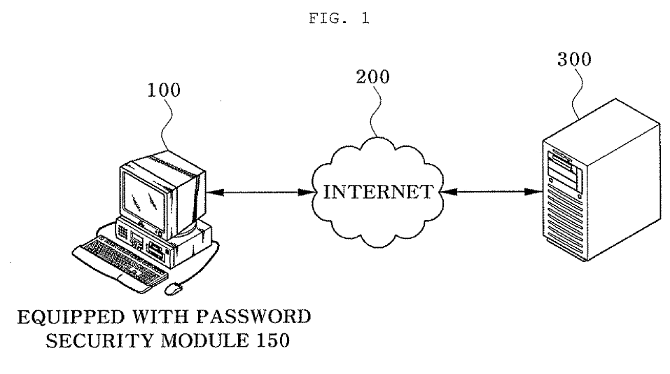

FIG. 1 schematically shows the constitution of a system for implementing a method of securing a password in a web page according to an exemplary embodiment of the present invention.

Referring to FIG. 1, the system for implementing a method of securing a password in a web page according to an exemplary embodiment of the present invention includes a user terminal 100 and a specific web server 300, which are connected with each other via the Internet 200.

Here, the user terminal 100 has a web browser to receive and display a web page, such as various Hypertext Markup Language (HTML) documents, provided by the web server 300 on a screen.

In addition, the user terminal 100 has a password security module 150 for securing a password in the web page provided by the web server 300.

In particular, the password security module 150 functions to effectively prevent a password value input to a password input window of the web page from being intercepted by a malicious program before the password value is transferred to the web server 300.

Preferably, the password security module 150 is implemented as software, but may also be implemented as hardware, and so on.

Meanwhile, the user terminal 100 is generally, for example, a computer such as a desktop Personal Computer (PC) or a notebook PC, but may also be any wired/wireless communication device that can access the specific web server 300 via the Internet 200 and use a variety of web services.

For example, the user terminal 100 may be a mobile terminal such as a cellular phone, a Personal Communication Service (PCS) phone, and synchronous/asynchronous International Mobile Telecommunication (IMT)-2000 phones. It may also be any wired/wireless home appliance or communication device that has a user interface for accessing the web server 300, such as a palm PC, a Personal Digital Assistant (PDA), a smart phone, a Wireless Application Protocol (WAP) phone, or a portable game device.

The Internet 200 refers to a worldwide open computer network structure providing Transmission Control Protocol/Internet Protocol (TCP/IP) and various services of upper layers, such as Hypertext Transfer Protocol (HTTP), telnet, File Transfer Protocol (FTP), Domain Name System (DNS), Simple Mail Transfer Protocol (SMTP), Simple Network Management Protocol (SNMP), Network File Service (NFS) and Network Information Service (NIS), and provides an environment allowing a user of the user terminal 100 to access the web server 300.

Meanwhile, the Internet 200 may be the wired or wireless Internet or a core network combined with a wired public network, a wireless mobile communication network, the mobile Internet, or so forth.

The web sever 300 generally functions to receive an HTTP or HTTPS request from the user terminal 100 having a web browser and respond to the HTTP or HTTPS request according to data contents that can be frequently found in a web page such as an HTML document.

Meanwhile, referring to a transfer path between the web browser of the user terminal 100 and the web server 300, the web browser of the user terminal 100 requests the web sever 300 for an HTML document indicated by a Uniform Resource Locator (URL) using HTTP or HTTPS, and the web server 300 searches for the requested HTML document and provides it to the web browser of the user terminal.

Then, the web browser shows the provided HTML document to the user through a screen of the user terminal 100 according to its format.

A method of securing a password in a web page according to an exemplary embodiment of the present invention will be described in detail below.

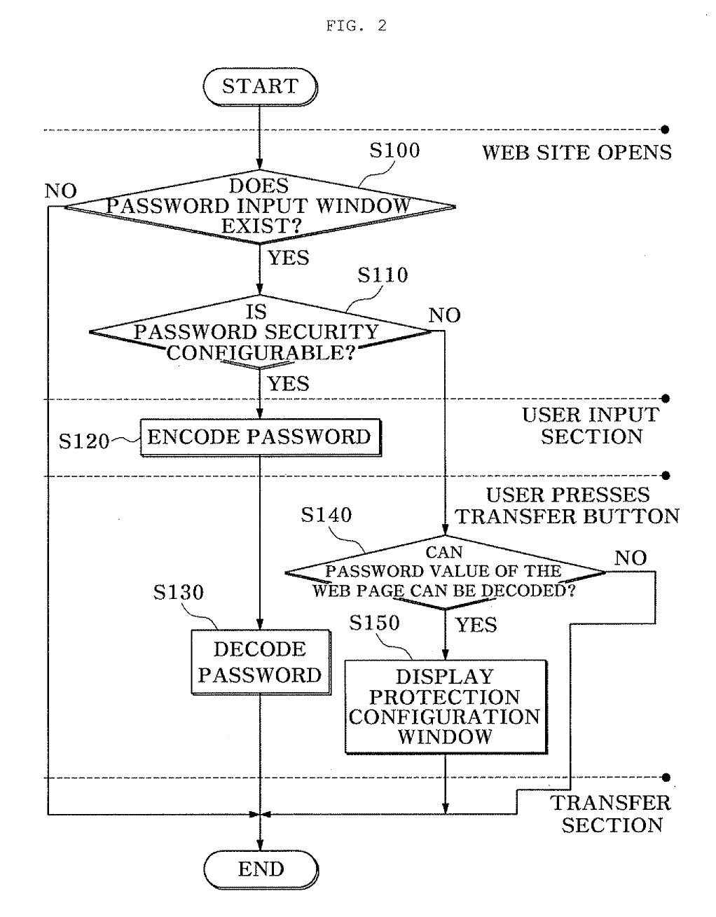

FIG. 2 is a flowchart showing a method of securing a password in a web page according to an exemplary embodiment of the present invention. Unless mentioned otherwise, the method is performed by the password security module 150.

Referring to FIGS. 1 and 2, when the user terminal 100 accesses the specific web server 300 through a web browser, opens a specific web site and receives a web page, the password security module 150 installed in the user terminal 100 determines whether or not a password input window exists in the currently accessed web page (step 100).

When it is determined in step 100 that a password input window exists in the current web page, it is checked whether or not password security, which is the present invention, has been configured for the current web page (step 110).

When it is determined in step 110 that password security has been configured for the current web page, it is checked whether or not a specific password value is input to the password input window existing in the current web page through the keyboard of the user terminal 100 When the specific password value has been input to the password input window, it is encoded (step 120).

Subsequently, when a log-in event, e.g., a click event and a keydown event, of a current web page occurs, the password value encoded in step 120 is then decoded (step 130). The password value decoded in step 130 is transmitted to the web server 300 providing the current web page.

More specifically, the specific password value input to the password input window is encoded and remain encoded until it is transmitted to the web server 300. Decoding of the password value occurs just before the password is transmitted to the web server 300. Thus, by doing this, it is possible to protect password or password-type information from malicious programs that intercepts password-type information from a web page or the system memory block of the user terminal 100.

Meanwhile, when it is determined in step 110 that password security has not been configured for the current web page, it is checked whether or not the current web page can be adequate for password security, verifying password encode and decode viability (step 140).

Step 140 may be performed when a user presses a transfer button, i.e., a log-in button on a web page, after inputting the specific password value to the password input window of the current web page using the keyboard.

Subsequently, when a log-in event of the current web page occurs in step 140, a protection configuration window for configuring password security according to the present invention is displayed in pop-up style on the screen of the user terminal 100 or on the currently opened web browser (step 150).

The above password security configuration will become effective from next time when a user accesses to the web page where password security is configured.

More specifically, the password value input to the password input window of the web page encoded, and the encoded password value is decoded upon it is being transmitted to the web server 300.

Additionally, step 120 may further include displaying the encoded password value in the password input window after encoding the password value input to the password input window.

Meanwhile, in step 120, the password value input to the password input window may further be enhanced if it is operated in conjunction with the general keyboard security technology, including Korean Patent Application No. 2006-0100366 entitled “Apparatus and Method for Preservation of USB Keyboard” filed by the present Applicant.

In addition, step 130 may further include storing the decoded password value in the password input window after decoding the password value.

Meanwhile, the method of securing a password in a web page according to an exemplary embodiment of the present invention can be stored on a computer-readable recording medium in the form of a computer-readable code. The computer-readable recording medium may be any recording device storing data that can be read by computer systems.

For example, the computer-readable recording medium may be a read-only memory (ROM), a random-access memory (RAM), a compact disk read-only memory (CD-ROM), a magnetic tape, a hard disk, a floppy disk, a mobile storage device, a non-volatile memory such as a flash memory, an optical data storage device, and so on. Also, the recording medium may be carrier waves, e.g., transmission over the Internet.

In addition, the computer-readable recording medium may be distributed among computer systems connected via a communication network and stored and executed as a code that can be read by a de-centralized method.

As is apparent from the above description, it is possible to effectively prevent a password value input to a password input window of a web page provided by a specific web server from being intercepted by malicious programs before the password value is transmitted to the web server.

It will be apparent to those skilled in the art that various modifications can be made to the above exemplary embodiments without departing from the spirit or scope of the invention. Thus, it is intended that the present invention covers all such modifications provided they come within the scope of the appended claims and their equivalents.

What is claimed is:

1. A method of securing a password in a web page, comprising:
(a) determining whether or not a password input window exists in a current web page accessed using a web browser of a user terminal;
(b) when it is determined in step (a) that a password input window exists in the current web page, checking whether password security can be configured for the current web page;
(c) when it is checked in step (b) that password security may be configured for the current web page, encoding a password value input which comes from a keyboard of the user terminal to the password input window of the current web page; and
(d) when a log-in event of the current web page occurs, decoding the encoded password value.

2. The method of claim 1, further comprising:
if it is checked in step (b) that password security is not configured for the current web page, displaying a pop-up window for password security configuration on a screen of the user terminal when the log-in event of current web page occurs.

3. The method of claim 1, wherein step (c) further comprises:
displaying the encoded password value in the password input window after encoding the password value input to the password input window.

4. The method of claim 1, wherein step (d) further comprises:
storing the decoded password value in the password input window after decoding the encoded password key value.

5. A method of accessing a web page provided by a specific web server through a web browser of a user terminal and then securing a password value input to a password input window provided by the web page, the method comprising:
encoding the password value input to the password input window, and then decoding the encoded password value at the same time when a log-in event of web page occurs.

6. The method of claim 5, further comprising:
displaying the encoded password value in the password input window after encoding the password value input to the password input window.

7. The method of claim 5, further comprising:
storing the decoded password value in the password input window after decoding the encoded password key value.

8. A computer-readable recording medium storing a program for executing the method of any one of claims 1 to 7.
